(19) United States
(12) Patent Application Publication
(10) Pub. No.: US 2010/0308519 A1
(43) Pub. Date: Dec. 9, 2010

(54) ELECTRO PERMANENT MAGNETIC APPARATUS WITH DUAL WORKING FACE

(76) Inventor: Uttam Sarda, Kolkata (IN)

Correspondence Address: HARNESS, DICKEY & PIERCE, P.L.C., P.O. BOX 8910, RESTON, VA, 20195, US

(21) Appl. No.: 12/734,873

(22) PCT Filed: Sep. 24, 2008
(86) PCT No.: PCT/IN2008/000610

§ 371 Date: May 28, 2010

(30) Foreign Application Priority Data
Nov. 30, 2007 (IN) 1621/KOL/2007

(51) Int. Cl. B25B 11/00

(52) U.S. Cl. 269/8

(57) ABSTRACT

An Electro Permanent Magnetic work holding apparatus with two working faces generating dual side magnetic flux with an innovative arrangement of permanent magnets for anchoring of ferromagnetic materials comprises of coils or electrical winding(s) (3), reversible magnet(s) (5) and non reversible magnet(s) (6) which are suitably selected and deployed between the two working faces (1 and 9) for magnetization and demagnetization of the said dual working faces.

The present invention relates to an electro permanent magnetic work holding apparatus with dual working face for anchoring of ferromagnetic materials. This invention more particularly relates to an electro permanent magnetic (hereinafter abbreviated as ‘EPM’ in this specification for the sake of brevity and convenience) work holding apparatus having dual working faces, thereby rendering the apparatus suitable for holding the work pieces magnetically on both side of the apparatus in the course of working/machining/anchoring.

In the prior art, Electro permanent magnetic (EPM) work holding apparatuses of flux reversal type are known in which a magnetic circuit is activated or deactivated by reversing the poles of the permanent magnets of the device. This is a combination of permanent magnetic and electro magnetic devices: it presents the advantages of the latter without the disadvantages of the former. These devices uses intrinsic energy of the permanent magnetic device but instead of being switched “ON” or “OFF” mechanically, it requires electrical pulse similar to electro magnetic devices but only momentarily delivered by an electrical winding. Once switched “ON”, these devices provide magnetic force for infinite duration of time independent of any external energy source. For instance, U.S. Pat. No. 4,507,635 granted to Michele Cardone of Milan, Italy, pertains to a magnetic anchoring apparatus, comprising in combination: an external ferromagnetic crown provided with a base plate and lateral walls; at least one group of four pole pieces defining pairs of corresponding poles of an anchoring surface, said pole pieces presenting their longitudinal axes at right angles to the base place and in correspondence with the apexes of a square. Moreover, the apparatus comprises a plurality of permanent magnets for feeding the aforesaid poles, interposed between the pole pieces, and between the latter and said ferromagnetic crown.

In metal working machines such as CNC machining centre, milling machines, electrical discharge machines (EDM), grinding machine, etc., a magnetic work holding apparatus is often used as a worktable, whereby a work piece to be machined can be held securely on the worktable by magnetic force, and then machining operation may be performed on the work piece.

The principal property of a magnet is its capability to attract ferromagnetic materials resulting from flow of magnetic energy called “flux” between magnetic north and south poles. When a ferromagnetic work piece is placed across the poles of a magnet, the “flux” passes through and the work piece gets attracted. The intensity of attraction or pull becomes stronger with the decrease in the distance of separation between the work piece and the magnet. Moreover, strength of attraction of a magnet is the function of the quantum of induction of magnetic flux into the work piece. It has also been observed that smooth surfaces are better attracted and held in position in comparison to uneven or rough surface.

Usually EPM apparatus has a single Magnetic working face, namely TOP face, for work holding and the other face, BOTTOM face, is clamped on the bed of the machine mechanically for holding the apparatus on the machine bed. Types of magnets presently available have magnetic poles (north and south) which are separated by non-magnetic insulators between the individual poles. The magnetic insulating material generally used may be selected from the group of epoxy, aluminium, brass, stainless steel, etc.

Present invention aims at circumventing and finding an effective solution to the difficulties encountered in the prior art.

The subject invention pertains to a work holding apparatus with at least two sets of non-reversible permanent magnets, and at least one set of reversible permanent magnet suitably placed, which may be commissioned for work holding by switching electrically.

The principal object of this invention is to provide a novel dual face magnetic work holding apparatus for machining/working/anchoring of ferromagnetic materials on either/both sides of the apparatus. This provides a work holding apparatus having an option of placing the apparatus vertically so that both sides can be used for work holding devices and performing machining operations thus avoiding use of two separate apparatus.

A further object of this invention is to provide better holding of apparatus with the machine bed which is enabled by the dual side magnetic “flux”. The conventional way of clamping anchoring devices was using mechanical clamping fixtures; however with the present innovation the clamping of the work holding apparatus to the machine bed is done magnetically. This provides better and uniform clamping of the apparatus with the machine bed.

The foregoing objects are achieved by the invention which relates to an Electro Permanent Magnetic work holding apparatus with two working faces generating dual-side magnetic flux with an innovative arrangement of permanent magnets for anchoring of ferromagnetic materials, characterized in that the said apparatus comprises of coils or electrical winding(s), reversible magnet(s) and non reversible permanent magnet(s) which are which are suitably selected and deployed between the two working faces for magnetization and demagnetization of the said dual working faces.

As a special feature of this invention 34, the work holding apparatus may deploy at least one reversible and at least two non reversible permanent magnets between the two working faces.

In the conventional Double side vertical work holding apparatus, the two sides of the apparatus were independent units which were mounted/assembled together. The present invention provides two work holding faces on a single magnetic work holding apparatus by generating dual side magnetic flux with an innovative arrangement of permanent magnets, whereby both sides of the apparatus can be magnetised or demagnetised simultaneously.

In a further embodiment of the present invention, there may be used only reversible magnets and coils for making the work holding apparatus. The switching “On and Off” of such an apparatus is done by magnetising and demagnetising the reversible magnets by injecting proper electrical signals to the coil.

In another embodiment of the present invention, there may be manually controlled permanent magnetic system provided on the working face/s of the apparatus which can be switched on/off manually so that the apparatus can be switched ON and OFF both mechanically and electrically.

In yet another embodiment of the present invention, the working faces of the EPM apparatus may be made both from a single monolithic ferromagnetic material, or one of the said faces may be fabricated from modular segments assembled together.

In yet another variant of the invention, there is avoided use of non magnetic insulating material like epoxy thereby eliminating possibilities of seepage of coolants to the coils which could lead to malfunctioning of the apparatus.

A further embodiment/variant of the invention provides Tee Slots around, along or across the perimeter of the poles to facilitate anchoring of the work pieces on one or both of the apparatus, irrespective of the magnetic properties.

This invention will now be described by means of the illustrative drawings accompanying this specification, in which—

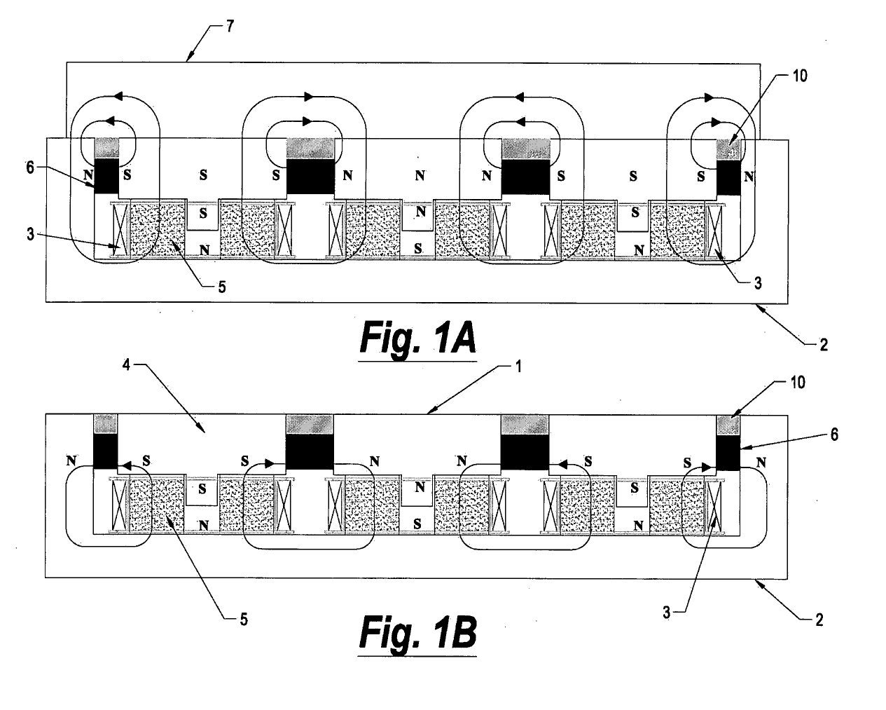

FIG. 1A shows a work holding apparatus as narrated in the earlier Patent Application No. 345/KOL/2005 in the magnetized condition, indicating the direction of lines of force.

FIG. 1B shows the apparatus of FIG. 1A in demagnetized condition with the direction of lines of force.

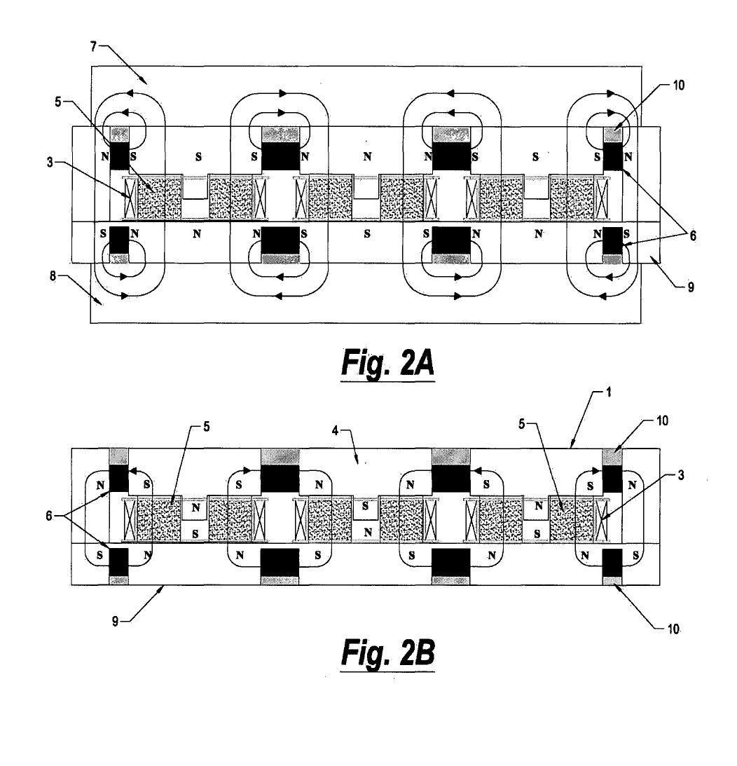

FIG. 2A illustrates an EPM apparatus of, this invention in the magnetized condition, including the direction of lines of force.

FIG. 2B shows the EPM apparatus of FIG. 2A in demagnetized condition.

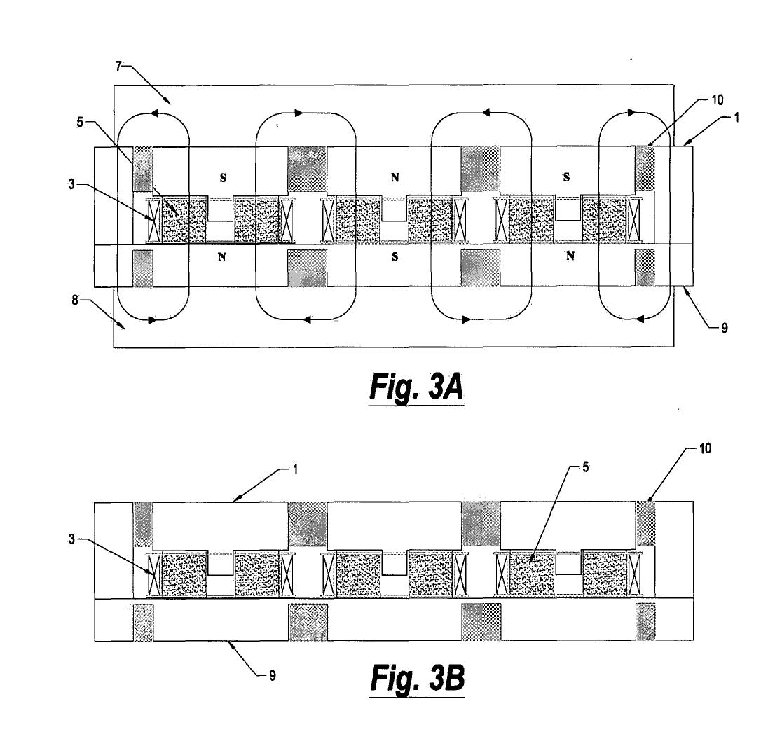

FIG. 3A illustrates another embodiment of this invention, wherein no irreversible magnets are used, along with the direction of the lines of forces.

FIG. 3B shows the EPM apparatus of FIG. 3A in demagnetized condition.

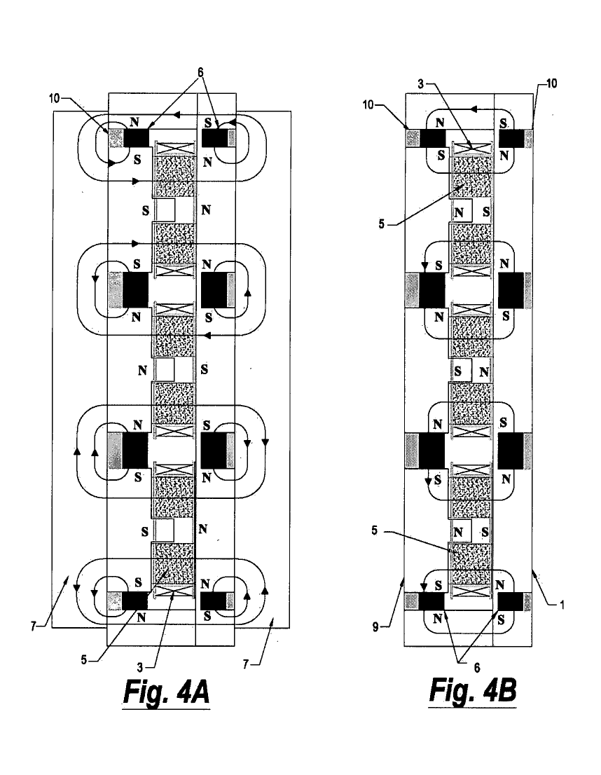

FIG. 4A is an another variation of the EPM apparatus illustrated in FIG. 2A of the drawings, wherein the said apparatus is set up in a vertical position, and show the direction of the lines of force in a magnetized condition, and

FIG. 4B depicts the EPM apparatus of FIG. 4A in demagnetized condition.

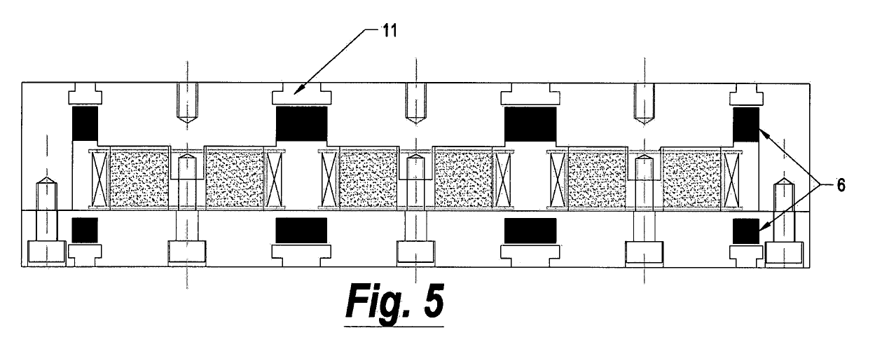

FIG. 5 shows another aspect of the invention wherein the EPM apparatus is additionally provided with Tee Slots for mechanical anchoring in addition to Magnetic clamping, as and when needed.

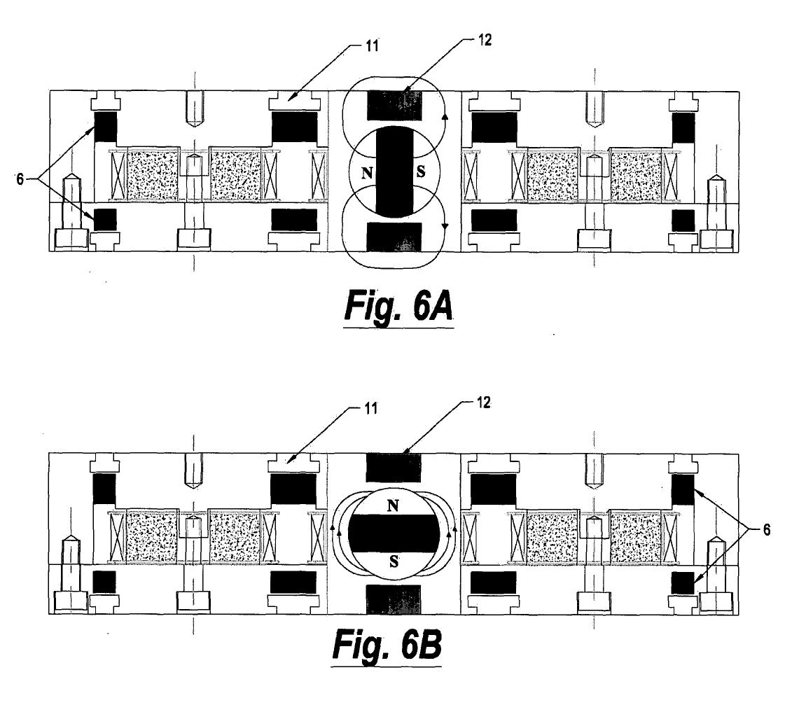

FIGS. 6 A and 6 B shows a variant of the apparatus equipped with additional permanent magnetic assembly.

The aforementioned FIGS. 1-6 (both A and B) will now be described in greater details, identifying the principle component parts with suitable numerals.

In FIGS. 1A and 1B the work holding face of the apparatus is (1), the base plate is (2), (3) shows the electrical windings. Demarked magnetic poles are shown as (4). First set of permanent, but reversible, magnets are denoted by (5) and the second set of permanent, non-reversible magnets are marked as (6). FIG. 1B shows the set-up in demagnetized condition.

FIG. 2A shows the assembly of the present invention holding a ferrous job (7) magnetically, thereby obviating the need to deploy additional holding means. Bottom working surface is shown as (9) and epoxy insulation for separating reversible or irreversible individual pole pieces is shown as (10). Numerals (1), (3), (5) and (6) have the same significance as in FIG. 1A. Machine bed is shown as (8). FIG. 2B shows the EPM apparatus in demagnetized condition.

FIG. 3A illustrates the assembly without irreversible magnets in magnetized condition. Numerals (1), (3), (5), (7), (8), (9) and (10) have the same significance as given in FIG. 1A. FIG. 3B depicts the EPM apparatus of FIG. 3A in demagnetized condition.

FIG. 4A depicts a unique feature of this invention, e.g. EPM apparatus with dual working faces deployed in a vertical manner, offering the facility of two working surfaces. FIG. 4.B shows the apparatus in Demagnetised condition.

FIG. 5 shows another aspect of the invention wherein the EPM apparatus is additionally provided with Tee Slots for mechanical anchoring in addition to Magnetic clamping.

FIGS. 6 A and 6 B shows a variant of the apparatus equipped with additional permanent magnetic assembly. The permanent Magnetic assembly can be switched On and Off by rotating the rotor and aligning the flux lines accordingly.

The advantages of the new invention may be summarized as follows:—
(1) The Novel Dual face magnetic work apparatus of this invention provides for double benefit by way of anchoring of ferromagnetic materials on both sides of the apparatus.
(2) One may exercise the option of placing the apparatus vertically so that both sides can be used for anchoring of the work pieces.
(3) Provides better holding of the apparatus to the machine bed due to dual side magnetic flux.
(4) Clamping of apparatus to the machine bed is simultaneous with the anchoring of the work piece which reduces cycle time as it eliminates mechanical clamping of apparatus to the machine bed.
(5) Provision of Tee Slots enables anchoring of work pieces of diamagnetic or paramagnetic nature by mechanical clamping on either or both working faces of the apparatus.
(6) The working face may be monolithic or modular segments assembled together for making such working face.
(7) In one of the variants of the invention there is avoided use of non magnetic insulating material on the working faces thereby eliminating all possibility of seepage of coolant and consequent malfunctioning/breakdown of the apparatus.
(8) The subject invention may be provided with additional manually controlled permanent magnetic system for switching On or off mechanically so that the apparatus can be switched ON and OFF both mechanically and electrically.

1. An Electro Permanent Magnetic work holding apparatus with two working faces generating dual side magnetic flux with an innovative arrangement of permanent magnets for anchoring of ferromagnetic materials, characterized in that the said apparatus comprises of coils or electrical winding, reversible magnet and non reversible permanent magnet which are suitably selected and deployed between the two working faces for magnetization and demagnetization of the said dual working faces.

2. A work holding apparatus as claimed in claim 1 wherein only reversible magnets and coils are used, the pole pieces of the said apparatus being separated by non magnetic insulating material.

3. A work holding apparatus as claimed in claim 1, wherein the said apparatus may be used either in horizontal or vertical position for anchoring separate work pieces, thereby avoiding the use of separate units.

4. A work holding apparatus as claimed in claim 1, wherein there is provided clamping of the apparatus with the work pieces and/or the machine bed there on by generating dual side magnetic flux with an innovative arrangement of permanent magnets.

5. A work holding apparatus as claimed in claim 1, wherein the working faces can either be made from a single monolithic ferromagnetic material, or one of the said faces may be made from modular segments assembled together resulting in a working face.

6. A work holding apparatus as claimed in claim 5, wherein there is avoided use of nonmagnetic insulating material on the working surfaces for separating the magnetic poles.

7. A work holding apparatus as claimed in claim 6 wherein Tee Slots are provided around, along or across the perimeter of the poles to facilitate anchoring of the work pieces on one or both working faces of the apparatus, irrespective of their magnetic properties.

8. A work holding apparatus as claimed in claim 1, wherein manually controlled permanent magnetic system is provided on the working faces of the apparatus, which enables the said working faces to be switched on or off both mechanically and electrically.

9. An electro permanent magnetic work holding apparatus with dual working faces for anchoring of ferromagnetic materials, substantially as hereinbefore described with particular reference to the accompanying drawings.
